(19) United States
(12) Patent Application Publication
(10) Pub. No.: US 2016/0140139 A1
(43) Pub. Date: May 19, 2016

(54) LOCAL REPRESENTATION OF SHARED FILES IN DISPARATE LOCATIONS

(71) Applicant: Microsoft Technology Licensing, LLC, Redmond, WA (US)

(72) Inventors: Melissa Torres, Kirkland, WA (US); Zhenguang Chen, Sammamish, WA (US); Carlos Perez, Seattle, WA (US); Qinjia Hackett, Bellevue, WA (US); John D. Fan, Redmond, WA (US); William David Taylor, Redmond, WA (US); Shilong Yao, Bellevue, WA (US); Trung Duc Nguyen, Bellevue, WA (US); David Harrison Goff, Seattle, WA (US); Dana Zircher, Cambridge, MA (US); John L. DeMaris, Seattle, WA (US)

(21) Appl. No.: 14/543,864

(22) Filed: Nov. 17, 2014

(51) Int. Cl. G06F 17/30; H04L 29/08

(52) U.S. Cl. CPC G06F 17/30174; H04L 67/26

(57) ABSTRACT

A mount point folder in a collaborative service library may reference contents of a mounted folder that resides elsewhere and includes actual files. File operations may be performed on files inside the mounted folder that may actually live across domains and changes to the contents of either folder may appear in the other. The mount point folder may be represented on the server as a file with .url extensions but in the client user experience, it may be represented as a folder. Mount point folders may be created at a root of a document library or within any other folder of the document library.

### BACKGROUND

With the proliferation of computing and networking technologies, users easily share and collaborate on documents in personal and professional lives. Any type of document to be collaboratively created, edited, and maintained by a number of people is not uncommon. However, collaborated and other relevant files may be located (stored) at various places. Individual collaborating users' local computing devices, enterprise networks, public networks, social and professional networks, cloud storage are just some examples of where files associated with a particular collaboration may reside.

When a user needs a file for a project they are working on, whether it is the file being collaboratively created or an ancillary file that contains relevant information, they may have to search their local data storage, their organization's network storage, other users' (collaborators') local storages, public data stores, and so on. They may then store a local copy of the file, which may never be used again, or which may not reflect the latest changes to it after a period. Moreover, performing these search and save operations for each file may be not only cumbersome, but also reduce individual and collaborative efficiencies dramatically. Existing systems are typically limited to files and folders that have been explicitly shared by a user through a “push” operation initiated by the content owner.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to local representation of shared files in disparate locations. According to some embodiments, subscribers of a collaborative service may be enabled to share items in disparate libraries of a cloud storage associated with the collaborative service; upon receiving an invitation to share an item from a first subscriber to a second subscriber, a mount point item may be created at a root library of the cloud storage referencing the shared item at its original storage location, where the shared item includes one or more of a folder and a file; the second subscriber may be enabled to select a location for the mount point item, to rename the mount point item, and to set permissions for contents of the mount point item; and file operations may be enabled to be performed on the shared item through the mount point item in a transparent manner to the second subscriber.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a conceptual diagram illustrating an example system, where local representation of shared files in disparate locations may be implemented;

FIG. 2A through 2C include example user experience presentations of local representation of shared files in disparate locations;

FIGS. 3A and 3B include conceptual diagrams illustrating example sharing and mounting of folders for local representation of shared files in disparate locations;

FIG. 4 illustrates an example sharing invitation for a folder through an email;

FIG. 5 illustrates an example user experience presentation of local representation of shared files in disparate locations along with local files;

FIG. 6 illustrates another example user experience, where multiple folders may be selected for sharing through local representation of shared files in disparate locations;

FIG. 7 is a block diagram of an example general purpose computing device, which may be used to implement local representation of shared files in disparate locations; and

FIG. 8 illustrates a logic flow diagram of a method to provide local representation of shared files in disparate locations, according to embodiments.

### GLOSSARY

Content—any form of structured data and streaming data that is associated with audio, video, graphics, images, and text.

User—a person with whom the content to be saved is associated.

Subscriber—an account holder with access to applications and cloud storage at a collaborative service.

Collaborative Service—a set of coordinated applications and associated cloud storage hosted by a plurality of servers providing access to the functionality of the applications and collaboration opportunities through web browser or locally installed client application user experiences to a plurality of users. The collaborative service may provide its services to “clients” or “tenants”, who in turn may allow users or subscribers to access the provided services.

Cloud storage—one or more data stores accessible through networks.

Permission level—a security setting that enables a user to control access to the content within a data storage.

Computing device—a device comprising at least a memory and a processor that includes a desktop computer, a laptop computer, a tablet computer, a smart phone, a vehicle mount computer, or a wearable computer.

Memory—a component of a computing device configured to store one or more instructions to be executed by one or more processors.

A processor—a component of a computing device coupled to a memory and configured to execute programs in conjunction with instructions stored by the memory.

File—any form of structured data that is associated with audio, video, graphics, images, and text.

Third party service—an independent service separate from a system used by the initiating user and the target user, another service, or an application.

Operating system—a system configured to manage hardware and software components of a computing device that provides common services and applications.

Integrated module—a component of an application or service that is integrated within the application or service such that the application or service is configured to execute the component.

Application—a program that when executed enables a user to communicate, create, edit, and share content.

Computer-readable memory device—a computer-readable storage medium implemented via one or more of a volatile computer memory, a non-volatile memory, a hard drive, a flash drive, a floppy disk, or a compact disk, and comparable hardware media that includes instructions thereon to automatically save content to a location.

User experience—a visual display associated with an application or service through which a user interacts with the application or service.

User action—an interaction between a user and a user experience of an application or a user experience provided by a service that includes one of touch input, gesture input, voice command, eye tracking, gyroscopic input, pen input, mouse input, and keyboards input.

Application programming interface (API)—a set of routines, protocols, and tools for an application or service that enable the application or service to interact or communicate with one or more other applications and services managed by separate entities.

### DETAILED DESCRIPTION

In a system according to embodiments, a user may browse or search through a broad corpus of files, files, sites, and collaborative workspaces throughout an organization (or organizations), and mount any item of his/her choosing, resulting in the original objects being represented as mounted files and folders in the user's collaborative space. To achieve the representation, a broad scope of object types are abstracted and represented as files and folders once they are mounted. For example, a document library in a team site of a collaboration service may be represented as a mounted folder. As briefly described above, to provide local representation of shared files in disparate locations, a folder in a collaborative service may reference contents of another folder. The representing folder may be referred to as a mount point folder and the referenced folder may be referred to as the mounted folder. The mounted folder may reside at any location accessible through networked communication and the files within the mounted folder may be accessible through the mount point folder without having those files physically reside at a local data store or a data store of the collaborative service. In various user experiences the contents of the mounted folder may appear as though they are contained in the mount point folder as well as in the original mounted folder. Thus, file operations, such as create, read, update, and delete operations, may be performed on files inside a mounted folder that may actually live across domains. The semantics of the contents of both folders may be that of a live copy, meaning changes to the contents of either folder may appear in the other. The mount point folder may be represented on the server as a file with .url extensions but in the client user experience, it may be represented as a folder, in some embodiments. Mount point folders may be created at a root of a document library or within any other folder of the document library.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for local representation of shared files in disparate locations. Examples of platforms include, but are not limited to, a hosted service executed over a plurality of servers, an application executed on a highest prioritized computing device, and comparable systems. The term “server” generally refers to a computing device executing one or more software programs typically in a networked environment. More detail on these technologies and example operations is provided below.

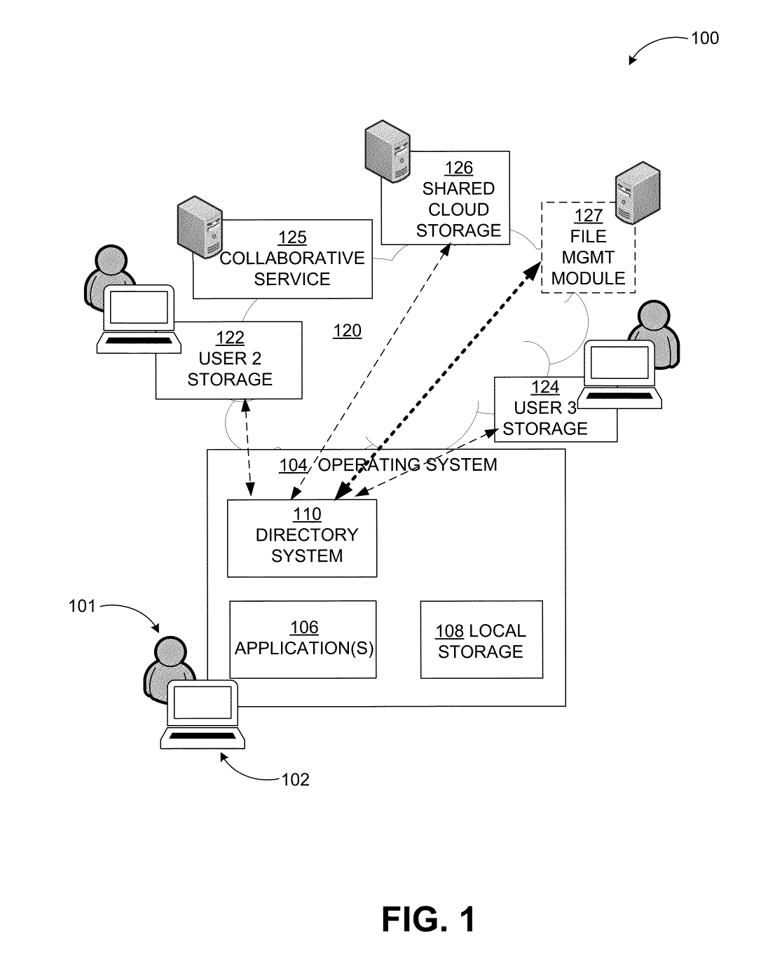

FIG. 1 includes a conceptual diagram 100 illustrating an example system, where local representation of shared files in disparate locations may be implemented;

In one example configuration, a computing device 102 such as a laptop computer may have an operating system 104. A number of applications such as application 106 may be executed within the infrastructure provided by the operating system 104. The applications may include any application such as word processing applications, spreadsheet applications, presentations applications, communication applications, imaging applications, audio/video processing applications, graphic processing applications, and comparable ones. Application 106 may process files as part of its operation, for example, open, save, load, modify. Application 106 may also enable the user 101 to view, edit, share, or perform other actions on the files. The files processed by the application 106 may be stored locally on the computing device 102, such as in local storage 108. Application 106 may also process files stored remotely such as shared storage 126, which may be accessible over one or more networks (or clouds) such as network 120.

Application 106 may be a thin or thick (rich) client enabling access to a collaborative service 125 and/or the shared cloud storage 126. Other users (user 2, user 3, etc.) may have access to the same collaborative service 125 or shared cloud storage 126. Each user may have their own storage (122, 124) in addition to the shared cloud storage 126. According to embodiments, a mount point folder in a collaborative service library may reference contents of a mounted folder that resides elsewhere and includes actual files. File operations may be performed on files inside the mounted folder that may actually live across domains and changes to the contents of either folder may appear in the other.

In some embodiments, when a folder is added to a cloud storage associated with a collaborative service, a mount point may be created the root folder of the cloud storage document library. The mount point may act as a shortcut or link to the original folder or mounted folder. Mount points may be renamed and moved in the cloud storage independent of the original mounted folder. Web or other client user experiences associated with the cloud storage may recognize a mount point as a pointer to a mounted folder and display a link that supports click-through navigation to the mounted folder. Client applications that regularly synchronize with the cloud storage may also recognize the mount point as a pointer to the mounted folder, and perform a selective synchronization with a collaborative service list containing the mounted folder on client startup. Client applications that support push notifications may register a push notification alert on the server for each root on startup, while other clients may poll for changes periodically. When content inside a root is changed at the server, the server may send the push notification alerts for each of the registered clients, which may trigger the clients to re-synchronize that root.

According to other embodiments, various user experience entry points for a user to send a request to add a mount point may be provided. Example entry points may include, but are not limited to sharing via email, item callout for folders in collaborative service document libraries and cloud storage document library, item callout on a “Shared with Me” page, a control element (e.g., a button) on user experience, recent documents, search result callout, or as additional controls and/or menu items in a rich client application associated with the collaborative service.

According to some embodiments, different behavior may be assigned to the mount point and mounted folders in situations of change, move, or deletion. For example, when a mounted folder is changed (for example: title, modified by, and modified date), the mount point folder may not be synchronized with the change. If the mounted folder is deleted or moved causing tuple values associated with the mount point to change, or user does not have permission anymore, the mount point may still be displayed in the cloud storage. A click on the mount point (navigation) may result in the resolve logic to fail, and the user experience may display error message in a dialog, for example prompting the user to unmount. When mount folder is moved and the move does not result tuple values to change, there may be no impact on displayed mount point folder. The href may be empty. Upon callout the URL may be temporarily incorrect until a resolve application programming interface (API) is called (as part of retrieving shared with information), and the URL is corrected. A move that results in tuple values to change may be treated same as the delete situation. Existing off-line clients (downstream) may interpret mount point list items as ordinary files. This may occur regardless as to whether the mount points represent folder mount points or file mount points. In some embodiments, a file management module 127 hosted by a third party service may provide the services associated with local representation of shared files in disparate locations through mount point items.

The computing device 102 may include a desktop computer, a laptop computer, a tablet computer, a vehicle mount computer, a smart phone, or a wearable computing device. The user 101 may be enabled to interact with the user experience through one or more of touch input, gesture input, voice command, eye tracking, gyroscopic input, pen input, mouse input, and/or keyboard input.

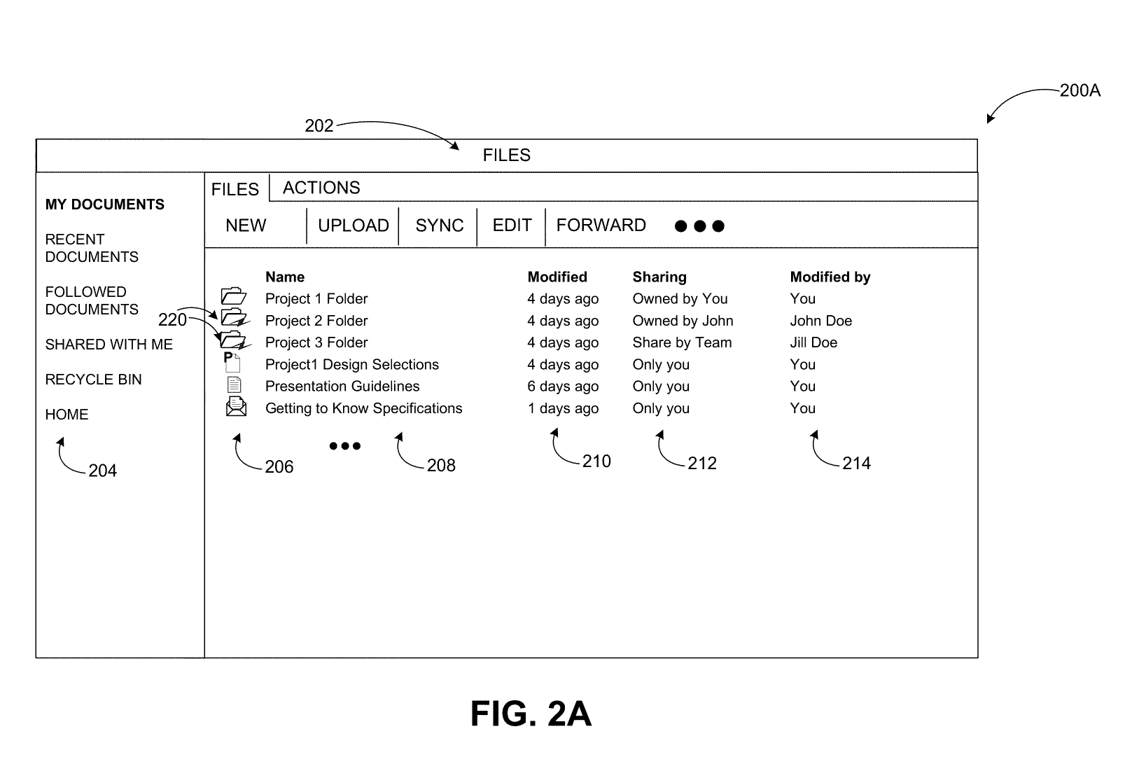

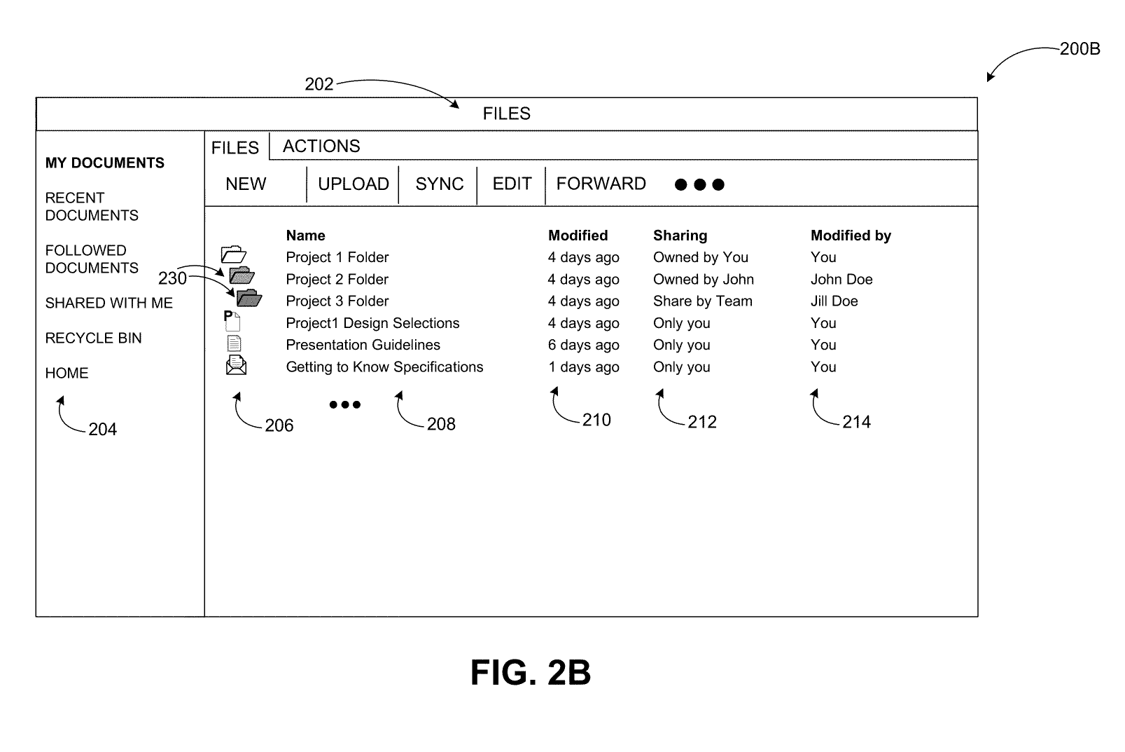

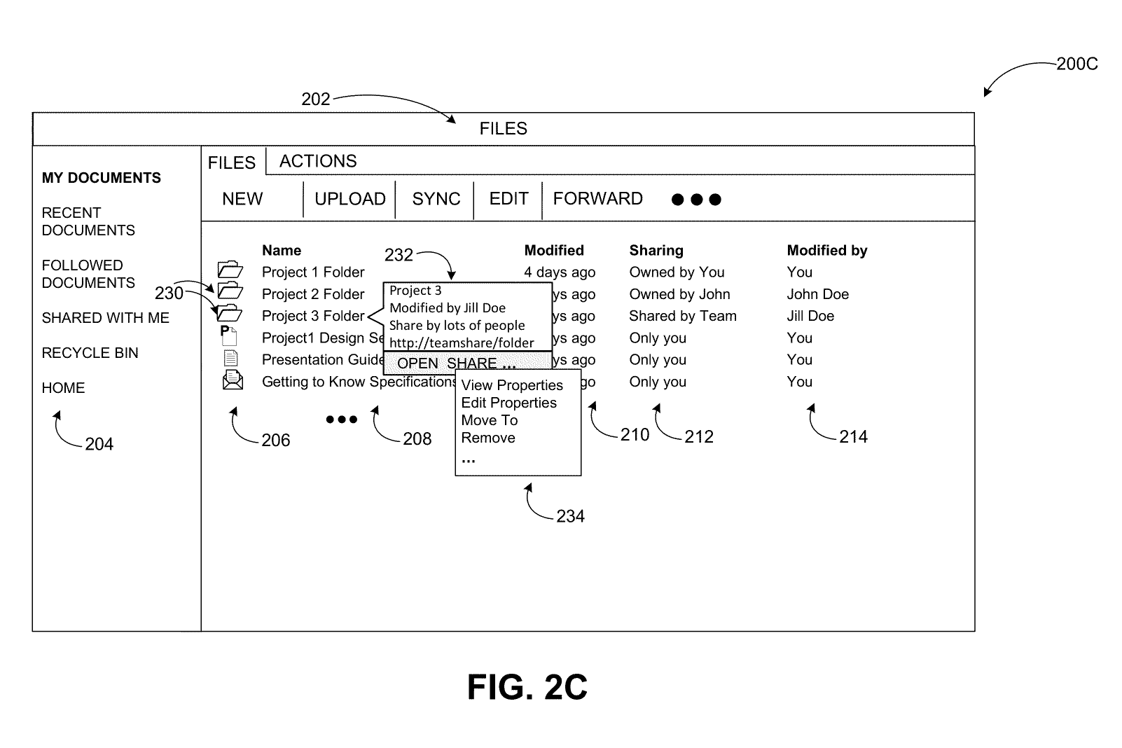

FIG. 2A through 2C include example user experience presentations of local representation of shared files in disparate locations.

In diagram 200A of FIG. 2A, a file management user experience 202 is shown with available libraries 204 listed on the left side and folders and files in a selected library (e.g., My Documents) listed in the main with available commands provided through menus on top. The listed items may be presented with icons 206, names 208, last modification date 210, sharing information 212, and modified by information 214. The icons 206 may represent different file or folder types. Among the list two example mount point folders 220 are distinguished by a different icon. From the user's perspective, these two may act like normal folders. Upon opening those folders, the user may see files that actually reside in a library of another user, a shared library, or even a public library. The user may perform file operations on those files while the mount point folder does not physically contain the files, just references to them.

Diagram 200B of FIG. 2B illustrates a similar user experience with slightly different representation of the mount point folders. In the example of diagram 200B, the mount point folders 230 are indicated by darker shading (or fill color). Furthermore, the mount point folders 230 display additional information. As mentioned above, mount point folders may be created at a root or within another folder. Through the use of indentation, the presentation of files in diagram 200B shows that one of the mount point folders is a sub-folder of another.

In diagram 200C of FIG. 2C, the listed items are represented such that there is no visible distinction between the mount point folders 230 and other folders. However, upon hovering on or selecting one of those folders, a pop-up menu 232 may be displayed providing detailed information on the mount point folder and displaying optional actions such as Open, Share, etc. to be performed on the folder. A further pop-up menu 234 may provide the option of viewing folder properties, editing the properties, moving the folder, removing the folder, or other comparable actions.

The user experiences in FIG. 2A through 2C are for illustration purposes only and any user experience with any configuration may be used to present mount point folders with various presentation schemes. The schemes may include one or more of a textual scheme, graphical scheme, color scheme, shading scheme, or similar method.

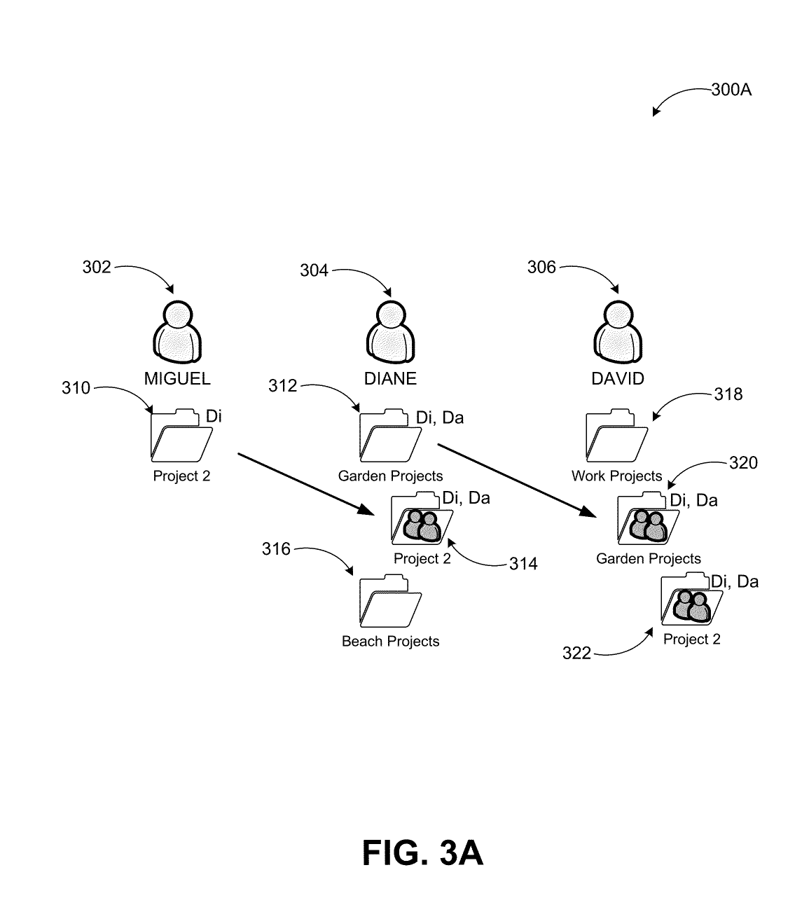

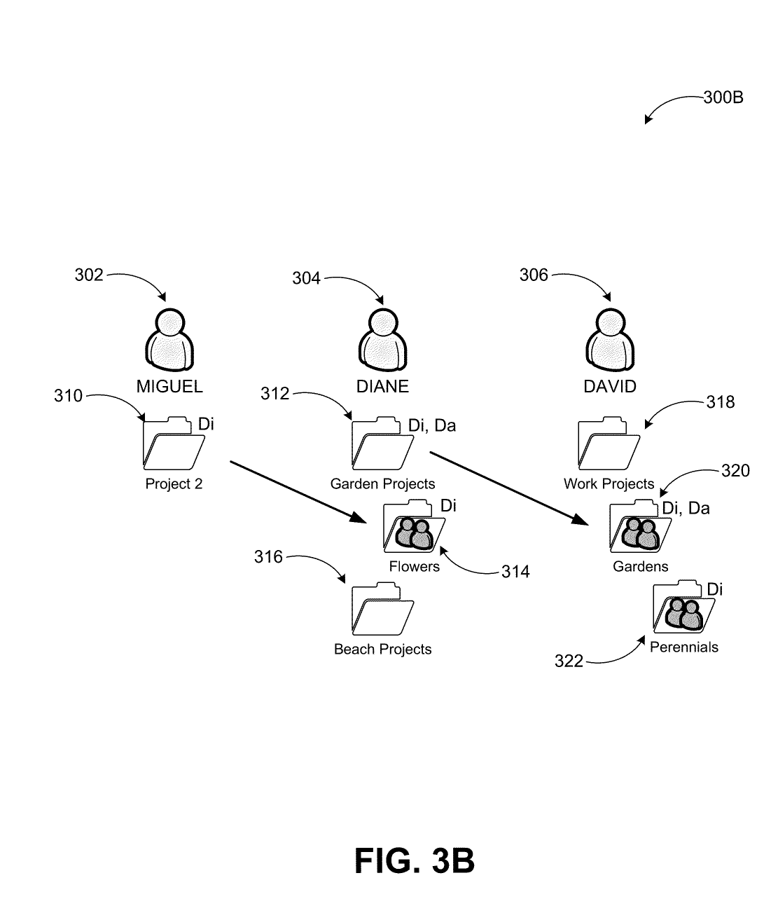

FIGS. 3A and 3B include conceptual diagrams illustrating example sharing and mounting of folders for local representation of shared files in disparate locations.

Mount point folders (or files) may be moved or shared among users with additional available actions. Diagram 300A of FIG. 3 shows one example scenario, where a first user 302, Miguel, shares a folder 310 called “Project 2” with a second user 304, Diane, giving Diane permissions to the folder and its contents. While the folder 310 is at the root of Miguel's library, Diane moves it into her top level folder 312 called “Garden Projects”. Thus, the folder 314 displayed as a sub-folder in Diane's library is now a mount point folder referencing the files, which reside actually in Miguel's library root.

Next, Diane decides to share her “Garden Projects” folder with a third user 306, David, and gives him permission to the folder and its subfolders. David moves the “Garden Projects” folder into his top level folder 318 called “Work Projects”. Thus, the folders 320 and 322 appearing within David's top level folder 318 called “Work Projects” are now mount point folders referencing files in Diane's “Garden Projects” folder and Miguel's “Project 2” folder, respectively. Because Diane gave permission to David, David may perform any operation on the files in the “Project 2” folder.

In other embodiments, the folders may be placed under other folders or any other configuration, they may be renamed by the recipients, and permissions may be assigned according to other rules. For example, Miguel may define what specific permissions Diane may have, as well as what permissions, she may give to downstream recipients. In one example, Miguel may allow Diane to read and delete the files, but not move. Miguel may also restrict the permission, Diane may give to others with whom she may share the folder to read only. Thus, in that scenario, David may receive only read permission for Miguel's files, but Diane may give other permissions to David for files that originate from her library.

Diagram 300B of FIG. 3B shows a scenario that is similar to diagram 300A with two distinctions: Diane may rename the mount point folder 314 as “Flowers” and David may yet rename both mount point folders 320 and 322 as “Gardens” and “Perennials”. Furthermore, Miguel may restrict delete, move, and edit permissions to Diane only. Therefore, David may have only read permission for the files in the “Perennials” mount point file 322.

The rules for defining/assigning file operation permissions as well as allowing re-share may be defined at a system level as default rules or they may be configurable by individual users. For example, certain users (e.g., IT staff), based on their credentials, may have default restrictions on what permissions they can give to others, while other users (e.g., Accounting staff) may have configurable restrictions. In other embodiments, the mount point folders may inherit permissions form their destination.

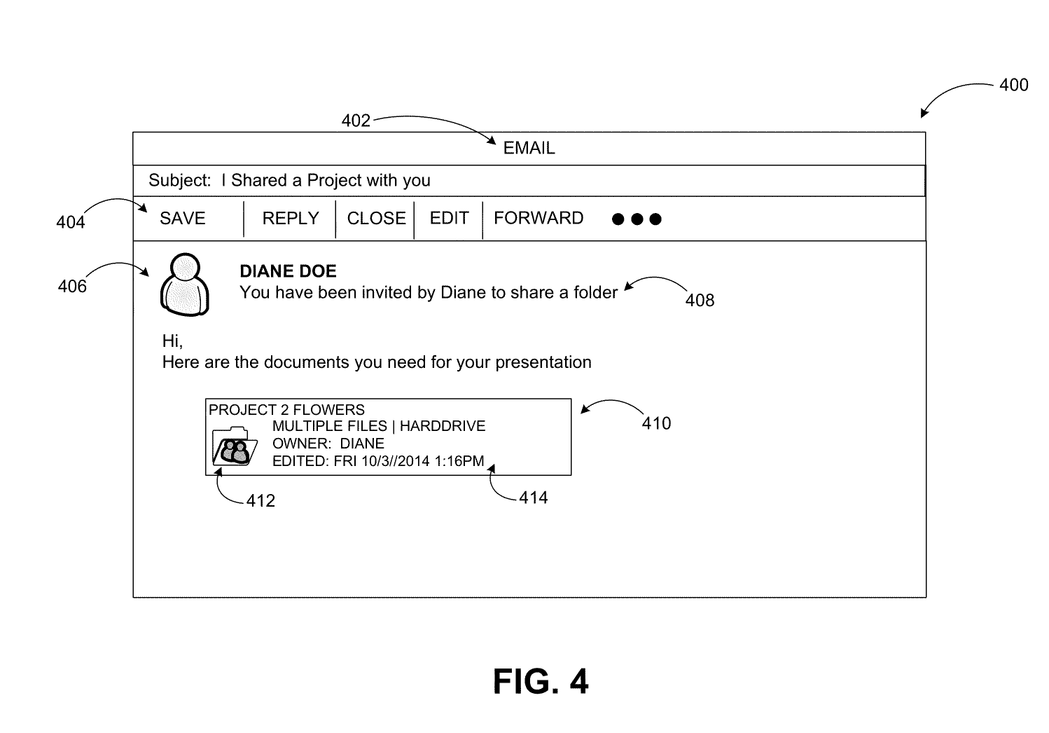

FIG. 4 illustrates an example sharing invitation for a folder through an email.

As mentioned previously, folder may be shared through mount point folder creation in a number of ways. Example share options may include, but are not limited to sharing via email, item callout for folders in collaborative service document libraries and cloud storage document library, item callout on a “Shared with Me” page, a control element (e.g., a button) on user experience, recent documents, search result callout, or as additional controls and/or menu items in a rich client application associated with the collaborative service.

Diagram 400 shows an example email invitation. The email user experience 402 includes email specific commands 404 and an identification (e.g., picture) 406 of the sender along with a subject line 408 that indicates the email is an invitation to share a folder. The body of the email (or another location on the user experience) may include an actionable representation 410 of the shared folder (or file) with a graphic representation 412 and summary information 414 on the shared folder. Upon activation (e.g. clicking on the icon or touching the representation), a pop-up menu may present the recipient with options on where to create the mount point folder, what permissions to set, how frequently to synchronize (in case of synchronization clients), or other options. Once created, the mount point folder may provide references to the original (mounted) files and allow the recipient to operate on the files as if they were on the recipient's own library.

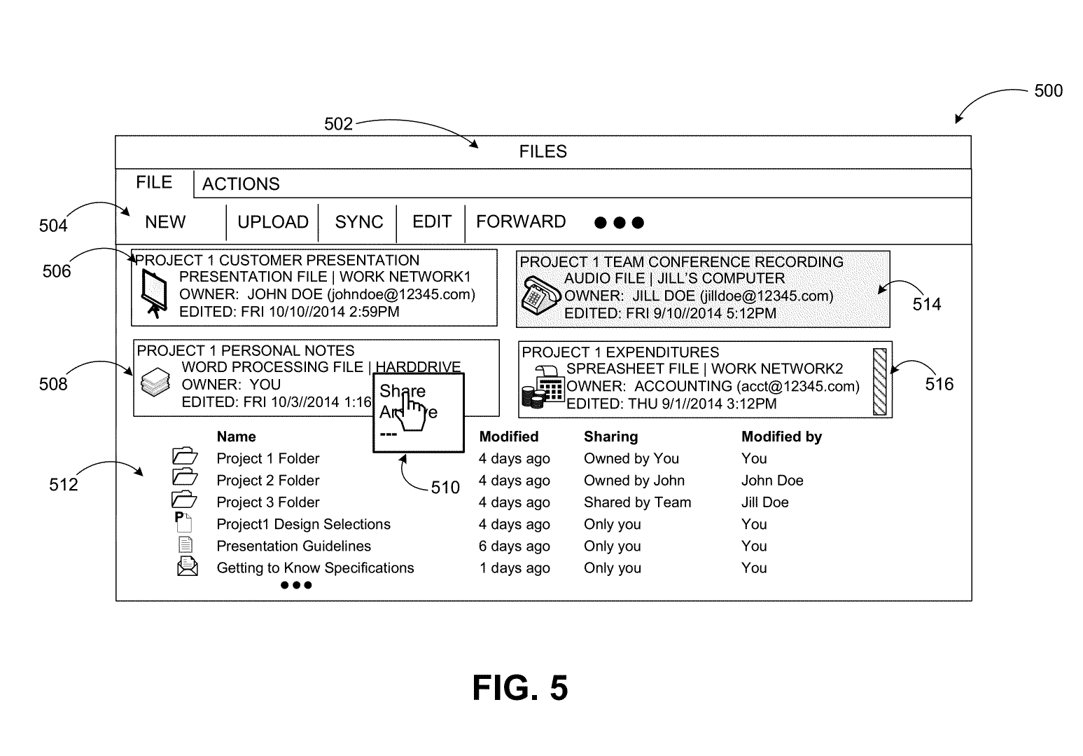

FIG. 5 illustrates an example user experience presentation of local representation of shared files in disparate locations along with local files.

Diagram 500 shows a file management user experience 502 with applicable commands 504 and represented files or folders in two groups. In the first group are files or folders 506, 508, 514, and 516 which are displayed in grid format with summary information. In the second group are files or folders 512 displayed in list format. Any of the displayed files or folders may be mount point files or folders indistinguishable from the others or distinguished through a graphic, color, shading, textual, etc. scheme. Further sharing ability may be provided by a pop-up menu 510, which may be displayed upon hover or selection action and allow the user to share the selected file or folder with other users as discussed previously.

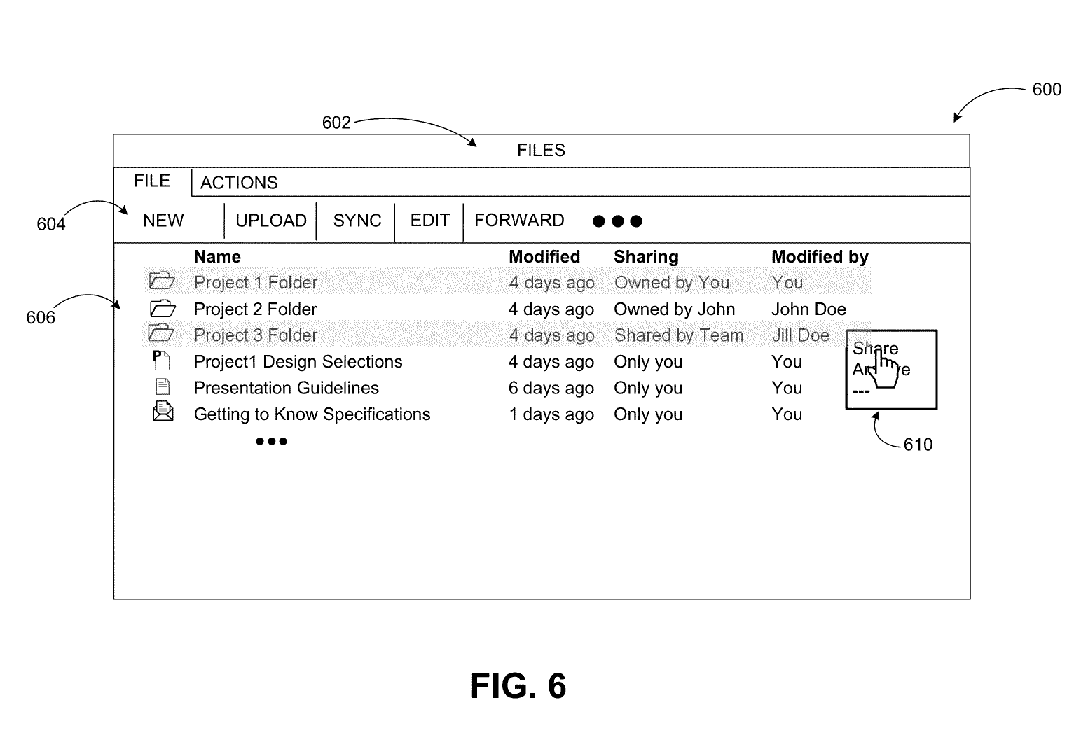

FIG. 6 illustrates another example user experience, where multiple folders may be selected for sharing through local representation of shared files in disparate locations.

The file management user experience 602 in diagram 600 show applicable commands 604 for a listing of files and folders 606 from a user's personal library. According to some embodiments, the user may select multiple files or folders and activate a “Share” control item (e.g., pop-up menu) 610 to share the selected files or folder with another user. The control item may allow the user to select a share method (e.g., send invitation by email), assign permissions, and perform other related actions.

In some other embodiments, metadata about changes to a file or folder may be pushed out to every mount point that contains it. Thus, clients may need only to synchronize with a single root, since the update to the mount point metadata may trigger a change notification in the containing root.

In further embodiments, a server-side synchronization option may logically run a synchronization client per cloud storage on the server to synchronize metadata about the content added to each cloud storage. This approach may have the same properties as the metadata push-out approach for read operations, but may change the writes from a push model to a pull model. In this approach, the read operations may be efficient, as they are a query to a single list.

In yet other embodiments, a server-side synchronization may be used for some operations, like search and flattened folder views, and a client-side synchronization may be used for reduced latency providing a hybrid technique.

In yet further embodiments, metadata may be queried about mount points on the server while the containing cloud storage is being enumerated (or optionally, asynchronously after the enumeration begins). Thus, overhead may be added when necessary (i.e., as opposed to writing metadata that is ultimately never read) and some of the complexities and failure points of fan-out writes may be reduced or eliminated.

The examples in FIGS. 1 through 6 have been described using specific network environments, systems, services, applications, and processes to provide local representation of shared files in disparate locations. Embodiments to implement mount point folders referencing mounted folders are not limited to the specific network environments, systems, services, applications, and processes according to these examples.

Local representation of shared files in disparate locations through a mount point folder—mounted folder pair, as described in the embodiments above, may help reduce processor load by enabling faster access to files as opposed to manual access for each file, which may involve multiple operations for each file to be processed. Network bandwidth usage may also be reduced through prevention of individual, manual file search and local storage operations. User efficiency may be improved by allowing users to see files in disparate locations in their local library without having to remember or think about where to search.

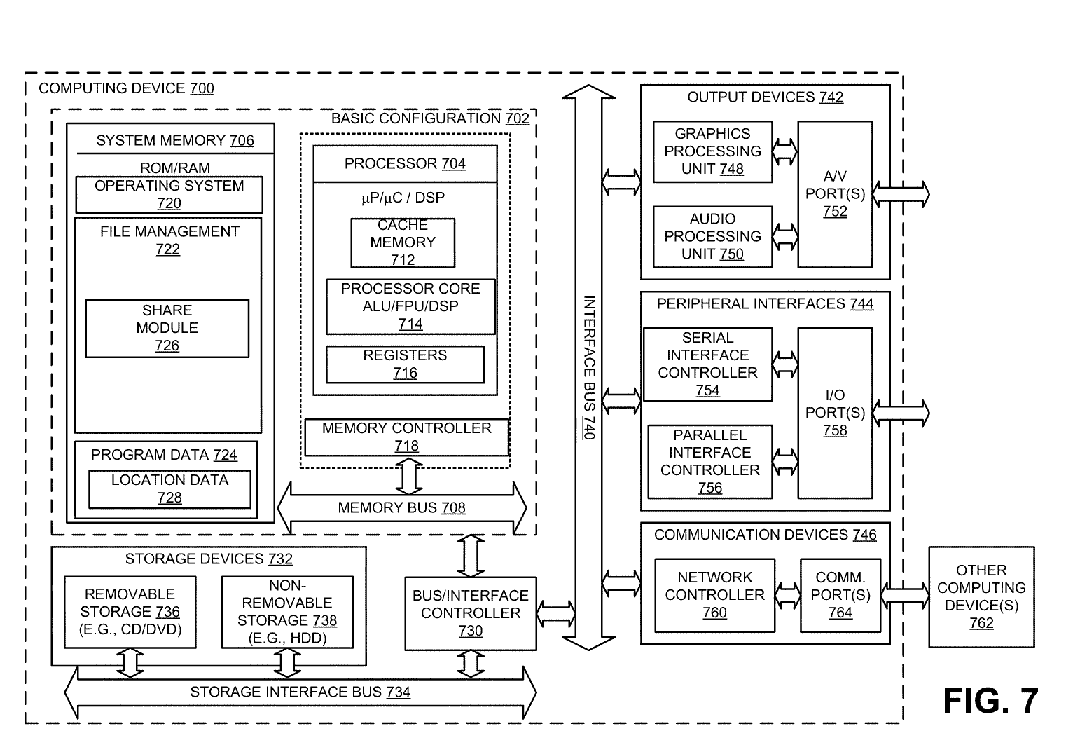

FIG. 7 is a block diagram of an example general purpose computing device, which may be used to implement local representation of shared files in disparate locations.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a file management application or service 722, and program data 724. The file management application or service 722 may include a share module 726, which may be an integrated module of the file management application or service 722 or an independent module. The share module 726 may perform tasks associated with local representation of shared files in disparate locations as described herein. The program data 724 may include, among other data, location data 728 related to locations of shared files, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to provide local representation of shared files in disparate locations. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

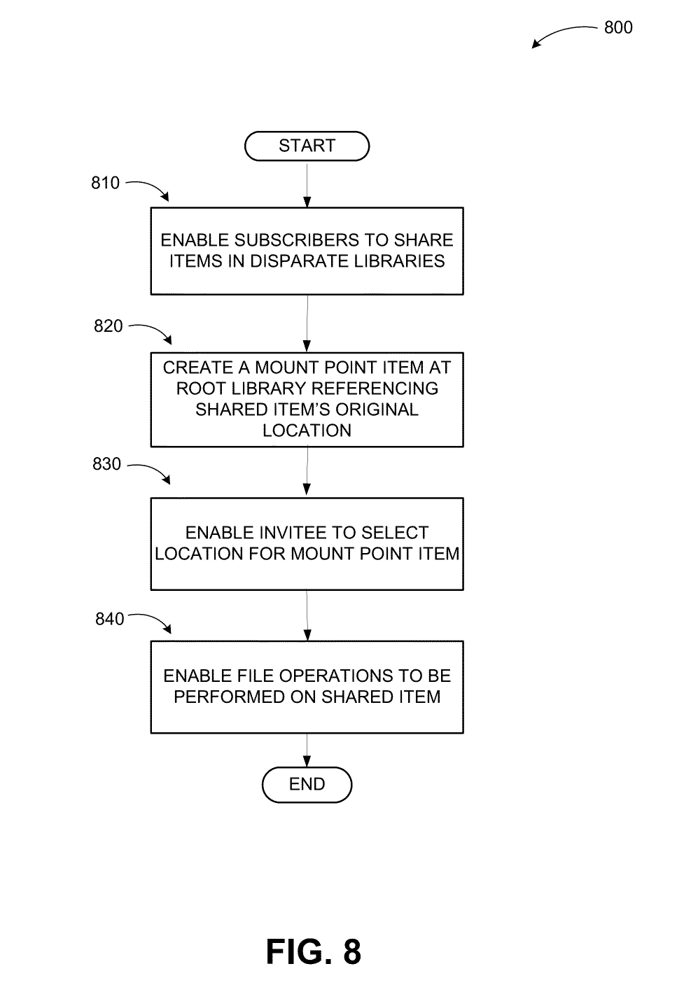

FIG. 8 illustrates a logic flow diagram of a method to provide local representation of shared files in disparate locations, according to embodiments. Process 800 may be implemented on a server or other computing devices.

Process 800 begins with operation 810, where subscribers of a collaborative service may be enabled to share items in disparate libraries of a cloud storage associated with the collaborative service. For example, they may be allowed to send an invitation email to share the item.

At operation 820, a mount point item may be created at a root library of the cloud storage referencing the shared item at its original storage location upon receiving an invitation to share an item from a first subscriber to a second subscriber. The shared item includes a folder with files or other folders within it or single a file.

At operation 830, the second subscriber may be enabled to select a location for the mount point item among their libraries. The second subscriber may also be enabled to rename the mount point item, to re-share the mount point item, and/or to set permissions for contents of the mount point item.

At operation 840, file operations may be enabled to be performed on the shared item through the mount point item in a transparent manner to the second subscriber. The operations may include create, read, update, delete, resolve, and enumerate operations.

The operations included in process 800 are for illustration purposes. Local representation of shared files in disparate locations may be implemented by similar processes with fewer or additional steps, as well as in different order of operations using the principles described herein.

According to some embodiments, a computing device to provide local representation of shared files in disparate locations is described. The computing device may include a display device, a memory configured to store instructions, and a processor coupled to the display device and the memory. The processor may be configured to create a mount point item at a root library of a cloud storage referencing the shared item at its original storage location upon receiving an invitation to share an item; enable an invitee to select a location for the mount point item; and enable file operations to be performed on the shared item through the mount point item in a transparent manner to the invitee.

According to other embodiments, the original storage location and the selected location may be in respective personal libraries of an inviter and the invitee associated with the cloud storage. The original storage location and the selected location may be in distinct domains. The processor may be further configured to enable rendering of the mount point item as one of a folder of files or a single file through a user experience of a file management application of the invitee. The processor may be configured to enable the invitee to select the location for the mount point item by allowing the invitee to place the mount point item in one of a personal root library or a folder within the personal root library. The file operations may include one or more of a create operation, a read operation, an update operation, and a delete operation.

According to further embodiments, the computing device may be a management server for a collaborative service and the cloud storage may be associated with the collaborative service. The mount point item may be represented at the management server as a file with one or more .url extensions each extension referencing a file or folder included in the shared item. The processor may be configured to support resolve and enumerate operations for web user experience and synchronization client applications associated with the collaborative service. The processor may be further configured to enable the invitee to rename the mount point item and enable the invitee to re-share the mount point item with another subscriber of the collaborative service. The processor may also be configured to enable the invitee to specify permissions for new invitees when re-sharing the mount point item.

According to yet other embodiments, a system to provide local representation of shared files in disparate locations is described. The system may include a first server configured to provide access to one or more applications as part of a collaborative service, a second server configured to manage cloud storage associated with the collaborative service, and a third server communicatively coupled to the first server and the second server. The third server may be configured to execute a file management module that is configured to enable subscribers of the collaborative service to share items in disparate libraries of the cloud storage; upon receiving an invitation to share an item from a first subscriber to a second subscriber, create a mount point item at a root library of the cloud storage referencing the shared item at its original storage location; enable the second subscriber to select a location for the mount point item; and enable file operations to be performed on the shared item through the mount point item in a transparent manner to the second subscriber.

According to yet further embodiments, the file management module may be further configured to enable the first subscriber to designate one or more permissions associated with the file operations to be performed on the shared item by the second subscriber; and enable the first subscriber to designate one or more permissions associated with the file operations to be performed on the shared item by other subscribers upon a re-share by the second subscriber. The file management module may be part of a third party service accessible by a plurality of computing devices over one or more networks.

According to some embodiments, the file management module may be configured to enable subscribers of the collaborative service to share items by one or more of: sharing via email, an item callout for folders in collaborative service document libraries and cloud storage document library, an item callout on a “Shared with Me” page, a control element on a user experience, recent documents, a search result callout, and as additional controls and/or menu items in a rich client application associated with the collaborative service. The file management module may also be configured to assign different behaviors to the mount point and the shared item in response to one of a change, a move, and a deletion; and if the shared item is deleted or moved causing tuple values associated with the mount point to change, continue to display the mount point in the cloud storage.

According to other embodiments, a method to provide local representation of shared files in disparate locations is described. The method may include enabling subscribers of a collaborative service to share items in disparate libraries of a cloud storage associated with the collaborative service; upon receiving an invitation to share an item from a first subscriber to a second subscriber, creating a mount point item at a root library of the cloud storage referencing the shared item at its original storage location, wherein the shared item includes one or more of a folder and a file; enabling the second subscriber to select a location for the mount point item, to rename the mount point item, and to set permissions for contents of the mount point item; and enabling file operations to be performed on the shared item through the mount point item in a transparent manner to the second subscriber.

According to further embodiments, the method may also include enabling a web client user experience associated with the cloud storage to recognize the mount point as a pointer to the shared item and display a link that supports click-through navigation to the shared item; enabling synchronization client applications that regularly synchronize with the cloud storage to perform a selective synchronization with a collaborative service list containing the shared item on client startup; and enabling client applications that support push notifications to register a push notification alert with the collaborative service for each root on startup. The method may further include sending a push notification alert to each registered client application in order to trigger the client applications to re-synchronize the shared item in response to a change in content of the shared item at the original storage location.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A computing device to provide local representation of shared files in disparate locations, the computing device comprising:
a display device;
a memory configured to store instructions;
a processor coupled to the display device and the memory; wherein the processor is configured to:
upon receiving an invitation to share a folder, create a mount point item at a root library of a cloud storage referencing the shared folder at its original storage location;
present one or more options for an invitee to select a location for the mount point item;
perform folder operations and file operations on files contained within the shared folder through the mount point item in a transparent manner to the invitee by:
displaying the mount point item as a folder among other folders associated with the invitee, wherein the mount point item contains links to the files contained within the shared folder,
performing folder operations and file operations selected by the invitee on the mount point item and the files associated with the mount point item, and
updating a presentation of the shared folder and the files contained within the shared folder displayed through the mount point item; and
enable the invitee to re-share the mount point item with another subscriber of the collaborative service by specifying permissions for the other subscriber when re-sharing the mount point item, wherein the permissions specified for the other subscriber are subject to configurable restrictions based on the invitee's credentials.

2. The computing device of claim 1, wherein the original storage location and the selected location are in respective personal libraries of an inviter and the invitee associated with the cloud storage.

3. The computing device of claim 1, wherein the original storage location and the selected location are in distinct domains.

4. (canceled)

5. The computing device of claim 1, wherein the processor is configured to enable the invitee to place the mount point item in one of a personal root library or a folder within the personal root library.

6. The computing device of claim 1, wherein the folder operations and file operations include one or more of a create operation, a read operation, an update operation, and a delete operation.

7. The computing device of claim 1, wherein the computing device is a management server for a collaborative service and the cloud storage is associated with the collaborative service.

8. The computing device of claim 7, wherein the mount point item is represented at the management server as a file with one or more .url extensions each extension referencing a file or folder included in the shared folder.

9. The computing device of claim 7, wherein the processor is configured to support resolve and enumerate operations for web user experience and synchronization client applications associated with the collaborative service.

10. The computing device of claim 7, wherein the processor is further configured to:
enable the invitee to rename the mount point item.

11. (canceled)

12. A system to provide local representation of shared files in disparate locations: the system comprising:
a first server comprising a communication module, a memory, and a processor, wherein the processor of the first server is configured to execute a collaborative service and to provide access to one or more applications as part of the collaborative service;
a second server comprising a communication module, a memory, and a processor, wherein the processor of the second server is configured to manage a cloud storage associated with the collaborative service; and
a third server comprising a communication module, a memory, and to processor, wherein the communication module of the third service is configured to communicatively couple the third server to the first server and the second server, and wherein the processor of the third server is configured to execute a file management module configured to:
enable subscribers of the collaborative service to share folders in disparate libraries of the cloud storage;
upon receiving an invitation to share a folder from a first subscriber to a second subscriber, create a mount point item at a root library of the cloud storage referencing the shared folder at its original storage location;
present one or more options for the second subscriber to select as location for the mount point item;
perform folder operations and file operations on the shared folder through the mount point item in a transparent manner to the second subscriber by:
displaying the mount point item as a folder among other folders associated with the second subscriber, wherein the mount point item contains links to the files contained within the shared folder,
performing folder operations and file operations selected by the second subscriber on the mount point item and the files associated with the mount point item, and
updating a presentation of the shared folder and the files contained within the shared folder displayed through the mount point item; and
enable the first subscriber to re-share the mount point item with the second subscriber by specifying permissions for the second subscriber when re-sharing the mount point item, wherein the permissions specified for the second subscriber are subject to configurable restrictions based on the first subscriber's credentials.

13. (canceled)

14. The system of claim 12, wherein the file management module is configured to enable subscribers of the collaborative service to share the folders by one or more of: sharing via email, an item callout for folders in collaborative service document libraries and cloud storage document library, an item callow on a “Shared with Me” page, a control element on a user experience, recent documents, a search result callout, and as additional controls and/or menu items in a rich client application associated with the collaborative service.

15. The system of claim 12, wherein the file management module is part of a third party service accessible by a plurality of computing devices over one or more networks.

16. The system of claim 12, wherein the file management module is further configured to:
assign different behaviors to the mount point and the shared folder in response to one of a change, a move, and a deletion.

17. The system of claim 16, wherein the file management module is further configured to:
if the shared folder is deleted or moved causing tuple values associated with the mount point to change; continue to display the mount point in the cloud storage.

18. A method to provide local representation of shared files in disparate locations, the method comprising:
enabling subscribers of a collaborative service to share folders in disparate libraries of a cloud storage associated with the collaborative service;
upon receiving an invitation to share a folder from a first subscriber to a second subscriber, creating a mount point item at a root library of the cloud storage referencing the shared folder at its original storage location;
presenting one or more options for the second subscriber to select a location for the mount point item, to rename the mount point item, and to set permissions for contents of the mount point item;
performing file operations on the shared folder through the mount point item in a transparent manner to the second subscriber by:
displaying the mount point item as a folder among other folders associated with the second subscriber, wherein the mount point item contains links to the files contained within the shared folder, and
performing folder operations and file operations selected by the second subscriber on the mount point item and the files associated with the mount point item, and
updating a presentation of the shared folder and the files contained within the shared folder displayed through the mount point item; and
enabling the first subscriber to re-share the mount point item with the second subscriber by specifying permissions for the second subscriber when re-sharing the mount point item, wherein the permissions specified for the second subscriber are subject to configurable restrictions based on the first subscriber's credentials.

19. The method of claim 18, further comprising:
enabling a web client user experience associated with the cloud storage to recognize the mount point as a pointer to the shared folder and display a link that supports click-through navigation to the shared folder;
enabling synchronization client applications that regularly synchronize with the cloud storage to perform a selective synchronization with a collaborative service list containing the shared folder on client startup; and
enabling client applications that support push notifications to register a push notification alert with the collaborative service for each root on startup.

20. The method of claim 19, further comprising:
in response to a change in content of the shared folder at the original storage location, sending a push notification alert to each registered client application in order to trigger the client applications to re-synchronize the shared folder.
